(19) United States
(12) Patent Application Publication
(10) Pub. No.: US 2016/0127963 A1
(43) Pub. Date: May 5, 2016

(54) METHODS FOR OPERATING NETWORK NODES AND RELATED NETWORK NODES

(71) Applicant: Telefonaktiebolaget L M Ericsson (publ), Stockholm (SE)

(72) Inventors: Gino Luca Masini, Stockholm (SE); Mats Folke, Lulea (SE)

(21) Appl. No.: 14/413,292

(22) PCT Filed: Dec. 8, 2014
(86) PCT No.: PCT/SE2014/051464

§ 371 Date: Jan. 7, 2015

Related U.S. Application Data
(60) Provisional application No. 61/968,731, filed on Mar. 21, 2014.

(51) Int. Cl. H04W 36/14; H04W 72/04

(52) U.S. Cl. CPC H04W 36/14; H04W 72/044; H04W 36/24

(57) ABSTRACT

According to some embodiments of inventive concepts, a method of operating a first node in a radio access network may be provided. The method may include communicating an authorization for a Proximity Services (ProSe) capability of a wireless device with a second node of the radio access network, wherein the authorization identifies at least one of a plurality of ProSe communication capabilities. The authorization for the ProSe capability of the wireless device may be communicated as an IE of an Initial Context Setup Request message, a UE Context Modification Request message, an S1 Handover Request message, and/or an X2 Handover Request message.

### BACKGROUND

Embodiments of the present disclosure relate generally to communications, and more particularly to wireless communications methods and nodes.

Device-to-device communication is a well-known and widely used component of many existing wireless technologies, including ad hoc and cellular networks. Examples include Bluetooth and several variants of the IEEE 802.11 standards suite such as WiFi Direct. These systems operate in unlicensed spectrum.

Recently, device-to-device (D2D) communications have been proposed as an underlay to cellular networks to take advantage of the proximity of communicating devices and at the same time to allow devices to operate in a controlled interference environment. Typically, it is suggested that such device-to-device communications share the same spectrum as the cellular system, for example, by reserving some of the cellular uplink resources for device-to-device purposes. Allocating dedicated spectrum for device-to-device purposes is a less likely alternative as spectrum is a scarce resource and (dynamic) sharing between the device-to-device services and cellular services may be more flexible and may provide higher spectrum efficiency.

LTE D2D scenarios currently studied in 3GPP (see, reference [2] 3GPP TR 22.803, reference [3] R3-131685, “Rapporteur Presentation on SI for D2D, Qualcomm, Incorporated,” and FIGS. 1 and 2) can be grouped in the following categories:

In-network;

Out-of-network; and

Partial-network.

FIG. 1 illustrates an LTE architecture, and FIG. 2 illustrates various D2D discovery and communication scenarios according to reference [2] R3-131685 from Qualcomm Incorporated, entitled “Rapporteur Presentation on SI for D2D”. In in-network scenarios, all participating UEs are within network coverage. In out-of-network scenarios, all participating UEs are outside network coverage. In partial-network scenarios, some participating UEs are within coverage and some are out.

In case a D2D UE is under network coverage (in-network scenarios), the radio resources it uses for D2D are set aside by the eNB, which reduces/avoids scheduling legacy traffic on the same resources to reduce/avoid interference. For in-network or partial-network scenarios, therefore, the eNB to which the D2D is connected has effectively less radio resources available for traffic, resulting in less available capacity.

Whether a UE is authorized to use ProSe (D2D) or not is signaled to the eNB using a “ProSe Authorized” indication when the ProSe-enabled UE connects or is handed over to the eNB. See, reference [7], 3GPP TS 23.303. When the ProSe UE connects to the eNB, the indication is signaled by the MME (Mobility Management Entity) in the S1AP Initial Context Setup Request procedures. When the ProSe UE is handed over to the eNB, the indication is signaled by the MME in the S1AP Handover Resource Allocation procedure (in case of S1 HO or S1HandOver) or by the source eNB in the X2AP Handover Preparation procedure (in case of X2 HO). See, Reference [7], 3GPP TS 23.303.

A ProSe (D2D) UE which is connected to an eNB will use radio resources (also referred to as frequency resources) for its D2D services which are assigned by the eNB and may therefore impact the QoS and/or capacity that the eNB provides to all other UEs.

### SUMMARY

According to some embodiments of inventive concepts, a method of operating a first node in a radio access network may be provided. The method may include communicating an authorization for a Proximity Services (ProSe) capability of a wireless device with a second node of the radio access network, and the authorization may identify at least one of a plurality of ProSe communication capabilities.

By identifying at least one of a plurality of ProSe communication capabilities, a network node receiving the authorization (e.g., a base station) may know not only if a UE is authorized for ProSe, but also which services the UE is authorized to support. Accordingly, the base station may be able to estimate an amount and type of resources that the UE may use according to the type of service.

Communicating may include communicating the authorization for the ProSe capability of the wireless device as an information element (IE) of an Initial Context Setup Request message, as an information element (IE) of a UE Context Modification Request message, and/or as an information element (IE) of an Si Handover Request message.

The first node may be a base station, the second node may be a Mobility Management Entity, and communicating may include receiving the authorization for the ProSe capability at the base station from the Mobility Management Entity. In addition, air-interface resources of the base station may be allocated and/or scheduled based on the authorization for the ProSe capability of the wireless device.

The first node may be a Mobility Management Entity, the second node may be a base station, and communicating may include transmitting the authorization for the ProSe capability from the Mobility Management Entity to the base station. In addition, the base station may be a handover target base station for the wireless device, a handover request may be received from a handover source base station for the wireless device at the Mobility Management Entity, and transmitting may include transmitting the authorization for the ProSe capability of the wireless device from the Mobility Management Entity to the handover target base station for the wireless device responsive to receiving the handover request from the handover source base station.

Communicating may include communicating the authorization for the ProSe capability as an information element (IE) of an X2 Handover Request message.

The first node may be a handover target base station for the wireless device, the second node may be a handover source base station for the wireless device, and communicating may include receiving the X2 Handover Request message including the authorization for the ProSe capability at the handover target base station from the handover source base station. In addition, air-interface resources may be allocated and/or scheduled at the handover target base station based on the authorization for the ProSe capability of the wireless device.

The first node may be a handover source base station for the wireless device, the second node may be a handover target base station for the wireless device, and communicating may include transmitting the X2 Handover Request Message including the authorization for the ProSe capability from the handover source base station to the handover target base station. The authorization for the ProSe capability of the wireless device may be received at the handover source base station from a Mobility Management Entity before transmitting the authorization for the ProSe capability of the wireless device to the handover target base station.

A handover request may be received at the handover source base station from the wireless device, and transmitting may include transmitting the X2 Handover Request Message including the authorization for the ProSe capability of the wireless device from the handover source base station to the handover target base station responsive to receiving the handover request from the wireless device.

A communication from the wireless terminal may be received at the handover source base station to initiate a handover from the handover source base station, and transmitting may include transmitting the X2 Handover Request Message including the authorization for the ProSe capability of the wireless device from the handover source base station to the handover target base station responsive to receiving the communication from the wireless device.

The authorization for the ProSe capability may include authorization for the wireless device to support a ProSe Device-to-Device (D2D) capability of the wireless device.

Communicating the authorization for the ProSe capability of the wireless device may include communicating an authorization for the wireless device to support at least one of ProSe direct discovery transmissions, ProSe direct communication transmissions, and/or UE-to-network relay transmissions.

Communicating the authorization for the ProSe capability of the wireless device may include communicating an authorization for the wireless device to support only one of ProSe direct discovery transmissions, ProSe direct communication transmissions, or UE-to-network relay transmissions.

The authorization for the ProSe capability may include authorization for the wireless device to support direct communication with another wireless device using radio resources of the radio access network. Moreover, the direct communication between the wireless devices may be direct communication that does not pass through any nodes of the radio access network.

According to some other embodiments of inventive concepts, a first node of a radio access network may include a network interface configured to communicate with a second node of the radio access network, and a processor coupled to the network interface. The processor may be configured to communicate an authorization for a Proximity Services (ProSe) capability of a wireless device with a second node of the radio access network through the network interface, and the authorization may identify at least one of a plurality of ProSe communication capabilities.

The processor may be configured to communicate the authorization for the ProSe capability of the wireless device as an information element (IE) of an Initial Context Setup Request message, as an information element (IE) of a UE Context Modification Request message, as an information element (IE) of an S1 Handover Request message, and/or as an information element (IE) of an X2 Handover Request message.

The processor may be configured to communicate the authorization for the ProSe capability by receiving the authorization from the second node through the network interface.

The processor may be configured to communicate the authorization for the ProSe capability by transmitting the authorization to the second node through the network interface.

According to still other embodiments of inventive concepts, a first node for use in a radio access network may be adapted to communicate an authorization for a Proximity Services (ProSe) capability of a wireless device with a second node of the radio access network. The authorization may identify at least one of a plurality of ProSe communication capabilities.

The first node may be adapted to communicate the authorization for the ProSe capability of the wireless device as an information element (IE) of an Initial Context Setup Request message, as an information element (IE) of a UE Context Modification Request message, and/or as an information element (IE) of an S1 Handover Request message.

The first node may be a base station, the second node may be a Mobility Management Entity, and the first node may be adapted to communicate by receiving the authorization for the ProSe capability at the base station from the Mobility Management Entity. In addition, the first node may be further adapted to allocate and/or schedule air-interface resources of the base station based on the authorization for the ProSe capability of the wireless device.

The first node may be a Mobility Management Entity, the second node may be a base station, and the first node may be adapted to communicate by transmitting the authorization for the ProSe capability from the Mobility Management Entity to the base station. Moreover, the base station may be a handover target base station for the wireless device, the first node may be further adapted to receive a handover request from a handover source base station for the wireless device at the Mobility Management Entity, and the first node may be adapted to transmit the authorization for the ProSe capability of the wireless device from the Mobility Management Entity to the handover target base station for the wireless device responsive to receiving the handover request from the handover source base station.

The first node may be adapted to communicate the authorization for the ProSe capability as an information element (IE) of an X2 Handover Request message.

The first node may be a handover target base station for the wireless device, the second node may be a handover source base station for the wireless device, and the first node may be adapted to communicate by receiving the X2 Handover Request message including the authorization for the ProSe capability at the handover target base station from the handover source base station.

The first node may be further adapted to allocate and/or schedule air-interface resources at the handover target base station based on the authorization for the ProSe capability of the wireless device.

The first node may be a handover source base station for the wireless device, the second node may be a handover target base station for the wireless device, and the first node may be adapted to communicate by transmitting the X2 Handover Request Message including the authorization for the ProSe capability from the handover source base station to the handover target base station.

The first node may be further adapted to receive the authorization for the ProSe capability of the wireless device at the handover source base station from a Mobility Management Entity before transmitting the authorization for the ProSe capability of the wireless device to the handover target base station.

The first node may be further adapted to receive a handover request at the handover source base station from the wireless device, and the first node may be adapted to transmit the X2 Handover Request Message including the authorization for the ProSe capability of the wireless device from the handover source base station to the handover target base station responsive to receiving the handover request from the wireless device.

The first node may be further adapted to receive a communication from the wireless terminal at the handover source base station to initiate a handover from the handover source base station, and the first node may be adapted to transmit the X2 Handover Request Message including the authorization for the ProSe capability of the wireless device from the handover source base station to the handover target base station responsive to receiving the communication from the wireless device.

The authorization for the ProSe capability may include authorization for the wireless device to support a ProSe Device-to-Device (D2D) capability of the wireless device.

The first node may be adapted to communicate the authorization for the ProSe capability of the wireless device by communicating an authorization for the wireless device to support at least one of ProSe direct discovery transmissions, ProSe direct communication transmissions, and/or UE-to-network relay transmissions.

The first node may be adapted to communicate the authorization for the ProSe capability of the wireless device by communicating an authorization for the wireless device to support only one of ProSe direct discovery transmissions, ProSe direct communication transmissions, or UE-to-network relay transmissions. The authorization for the ProSe capability may include authorization for the wireless device to support direct communication with another wireless device using radio resources of the radio access network.

The direct communication between the wireless devices may include direct communication that does not pass through any nodes of the radio access network.

### BRIEF DESCRIPTION OF THE DRAWINGS

FIG. 1 is a schematic diagram illustrating an LTE architecture;

FIG. 2 is a schematic diagram illustrating various D2D discovery and communication scenarios;

FIG. 3 is a schematic diagram illustrating a ProSe UE-to-Network relay;

FIG. 4 provides a table (Table 1) illustrating a ProSe authorized IE, defined as an enumerated type value, according to some embodiments of inventive concepts;

FIGS. 5A, 5B, and 5C provide a table (Table 2) illustrating a modified Initial Context Setup Request message according to some embodiments of inventive concepts;

FIG. 6 provides a table (Table 3) illustrating a modified UE Context Modification Request message according to some embodiments of inventive concepts;

FIGS. 7A and 7B provide a table (Table 4) illustrating a modified Handover Request message according to some embodiments of inventive concepts;

FIGS. 8A, 8B, and 8C provide a table (Table 5) illustrating a modified X2 Handover Request message according to some embodiments of inventive concepts;

FIG. 9 provides a table (Table 6) illustrating a ProSe authorized IE, defined as a list of values, according to some embodiments of inventive concepts;

FIG. 10 is a message diagram illustrating an initial context setup message according to some embodiments of inventive concepts;

FIG. 11 is a message diagram illustrating a UE context modification request message according to some embodiments of inventive concepts;

FIG. 12 is a message diagram illustrating an S1 HandOver Request Message according to some embodiments of inventive concepts;

FIG. 13 is a message diagram illustrating an X2 HandOver Request Message according to some embodiments of inventive concepts;

FIG. 14 is a block diagram illustrating a mobility management entity according to some embodiments of inventive concepts; and

FIG. 15 is a block diagram illustrating a base station according to some embodiments of inventive concepts.

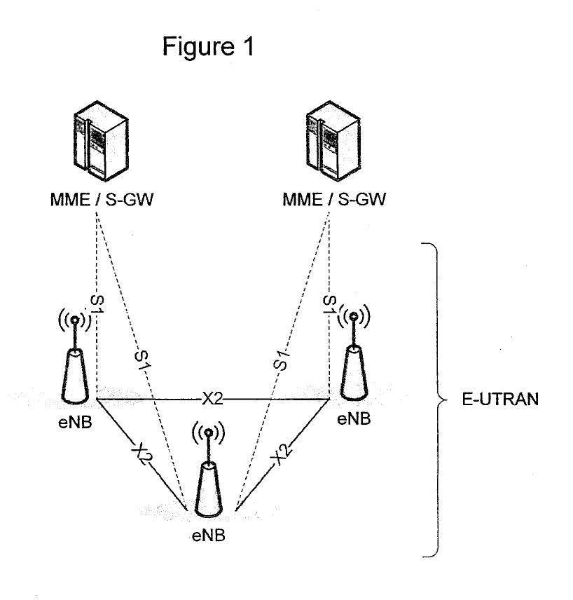

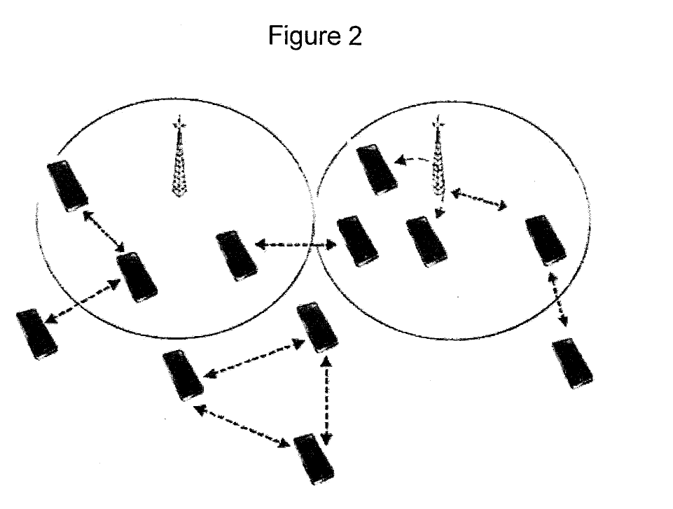

### DETAILED DESCRIPTION

When a UE (also referred to as a user equipment, a user equipment node, a wireless device, or a wireless terminal) in D2D (Device-to-Device) operation is also connected to an eNB (also referred to as an eNodeB or a base station) cell of a radio access network, the eNB may be unable to use the radio resources used by the UE for D2D due to D2D interference, which would cause degraded signal quality to other UEs connected to the same cell. From a capacity point of view, this may result in the eNB having fewer radio resources available for traffic. When the eNB receives a “ProSe Authorized” indication, it may have no knowledge of what type of services the UE will directly provide to other UEs so it may have no way of estimating an amount of resources that the UE will require beforehand. Another problem is that there may be no way to signal to the eNB that a UE already connected has subsequently been authorized for ProSe (or will provide different ProSe services) without first removing the UE context from the eNB (i.e., dropping the connection).

By defining the ProSe Authorized IE (Information Element), for example, as an enumerated type or as a list of values, it may be possible to signal to the eNB additional information about what types of service(s) the ProSe UE is authorized to support. In addition, the same IE can be added to the UE CONTEXT MODIFICATION REQUEST message so that the ProSe authorizations for the UE can be modified without requiring the context to be first removed (and the connection to be consequently dropped).

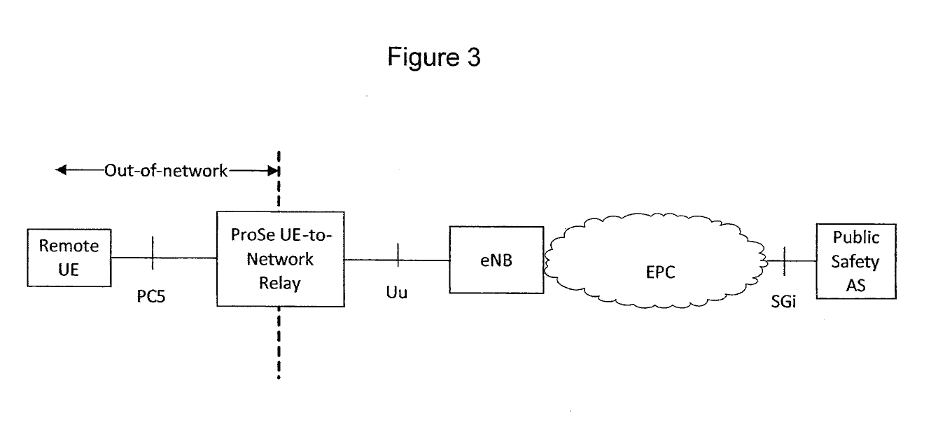

When receiving a ProSe Authorized IE as defined above, the eNB may know not only if the UE is authorized for ProSe, but also which services it is authorized to support. It may be possible therefore for the eNB to estimate the amount and type of resources that the UE may require according to the type of service. For example, ProSe direct discovery by itself may require relatively few radio resources and may generate relatively little or no traffic toward the EPC (evolved packet core). ProSe direct communication may likely require more radio resources than direct discovery and may still generate little or no traffic toward the EPC. UE-to-network relay services (e.g., illustrated in FIG. 3) may likely require considerably more radio resources and may generate considerably more traffic toward the EPC. As shown in FIG. 3, for example, an in-network UE may act as a ProSe UE-to-Network Relay providing connection between an out-of-network remote UE (over a PC5 interface) and a radio access network base station eNB (over a Uu interface). Communications between the out-of-network remote UE and a public safety application server AS (or other server), for example, may be provided through/over the PC5 interface, the in-network UE (acting as a ProSe UE to network relay), the Uu interface, base station eNB, an evolved packet core EPC, and an SGi interface. The eNB may thus allocate its internal resources and/or reschedule its served UEs accordingly.

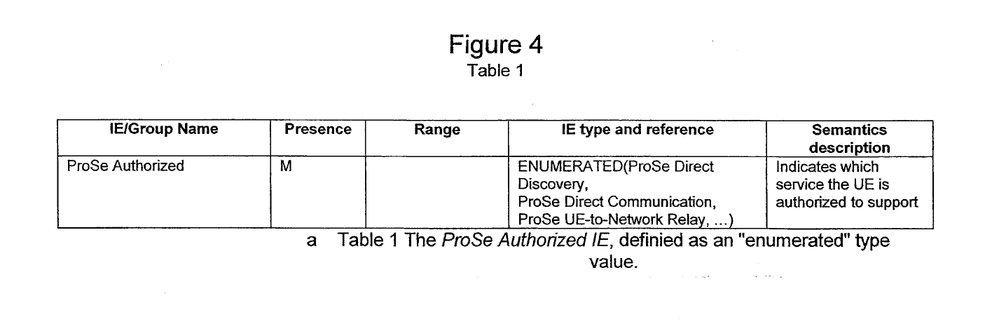

In some embodiments of inventive concepts, the ProSe Authorized IE (Information Element) may be defined as an “enumerated” type value as shown in Table 1 of FIG. 4. The purpose of the ProSe Authorized IE is to indicate to the eNB the type of services the UEs is authorized to support: ProSe Direct Discovery, ProSe Direct Communication, ProSe UE-to-Network Relay.

This information is already available in the MME (Mobility Management Entity) because the ProSe UE includes this capability indication as part of the “UE Network Capability” or “MS Network Capability” in the Attach Request message, and the MME stores this information. See, Reference [7], 3GPP TS 23.303 v. 12.0.0.

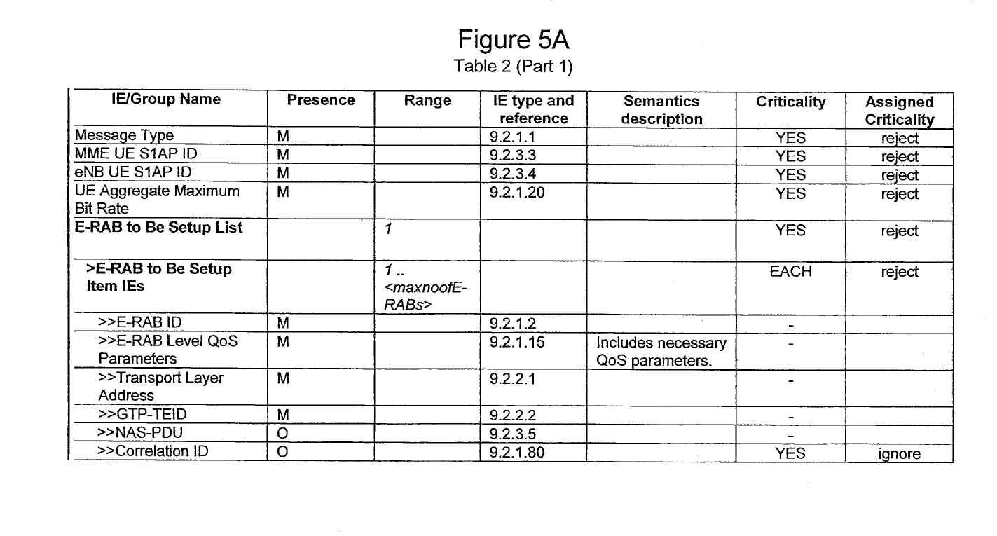

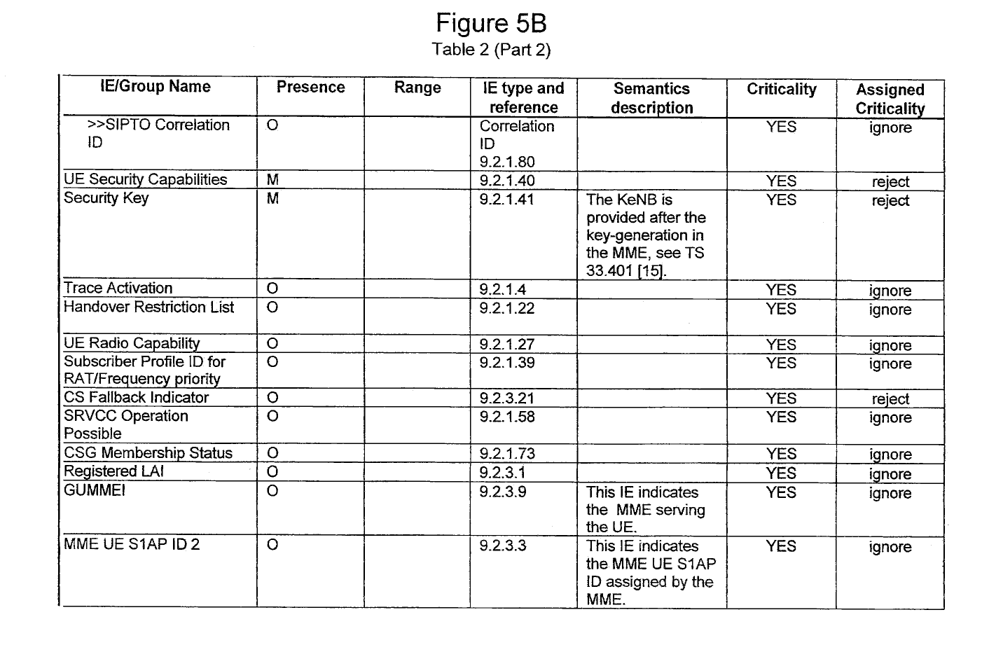

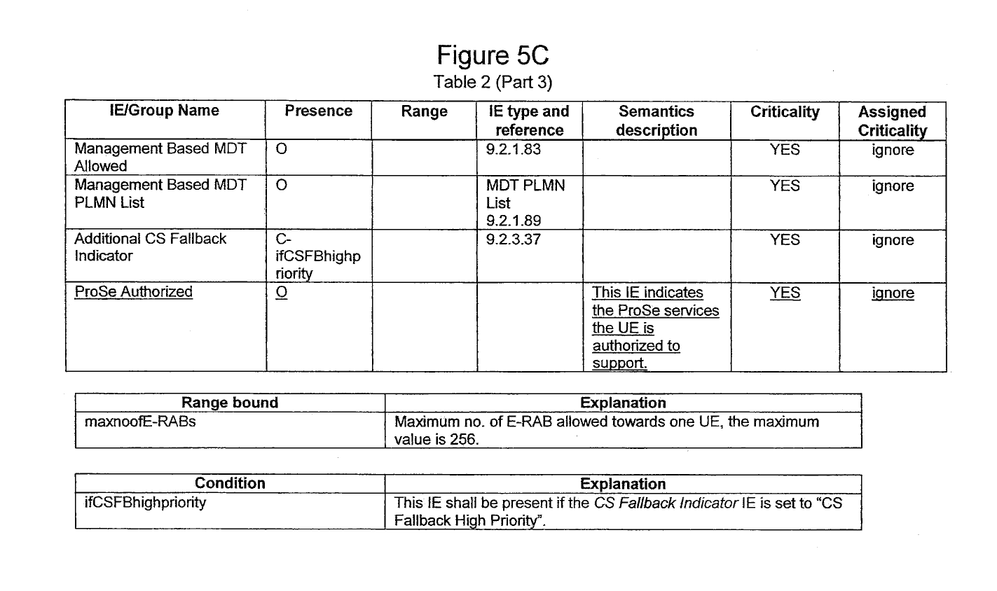

The MME may send the information in Table 1 (shown in FIG. 4) above to the eNB as a new element of the S lAP INITIAL CONTEXT SETUP message. See, Reference [6], 3GPP TS 36.413 v. 12.1.0. The modified INITIAL CONTEXT SETUP REQUEST message is shown in Table 2 of FIGS. 5A, 5B, and 5C. The modification is indicated with underline in FIG. 5C.

If for some reason the eNB cannot accommodate the ProSe services as requested (e.g., if it does not allow D2D relay but only discovery and communication), the eNB replies with the INITIAL CONTEXT SETUP FAILURE message (see, reference [6], 3GPP TS 36.413, v.12.1.0) including an appropriate cause value, e.g. “ProSe service not allowed”.

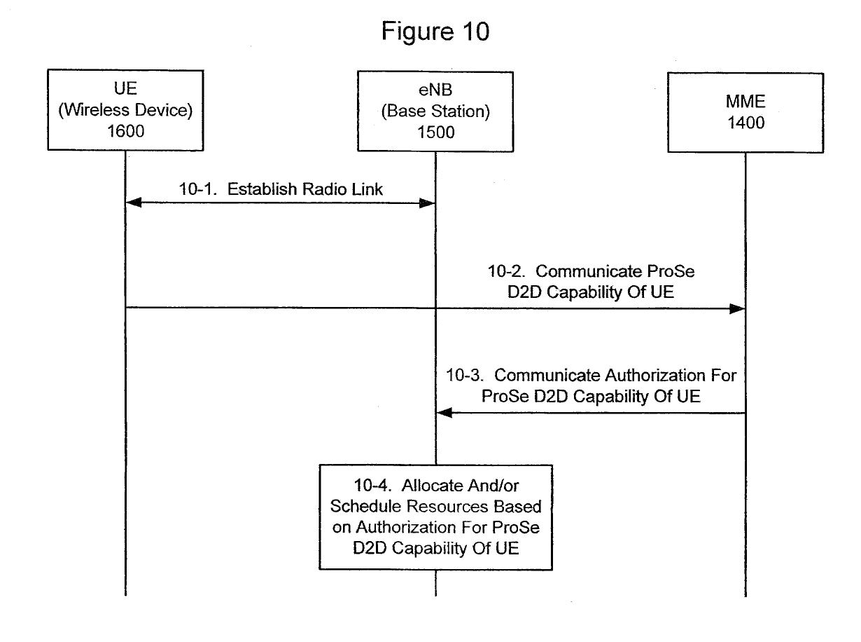

FIG. 10 is a message diagram illustrating use of an Initial Context SetUp message to communicate an authorization for a ProSe capability of a UE 1600 according to some embodiments. For example, a radio link may be established (10-1) between UE (wireless device) 1600 and the serving eNB (base station) 1500, the UE 1600 may transmit (10-2) a communication (through the eNB 1500) to the MME 1400 identifying one or a plurality of ProSe D2D capability/capabilities (e.g., ProSe direct discovery, ProSe direct communication, and/or ProSe UE-to-network relay), and the MME 1400 may receive (10-2) the communication. This communication may be provided as an Attach Request message. The MME 1400 may then transmit (10-3) an authorization for a ProSe capability identifying at least one of a plurality of ProSe communication capabilities (e.g., ProSe direct discovery, ProSe direct communication, and/or ProSe UE-to-network relay), and the eNB 1500 may receive (10-3) the authorization.

The authorization may be transmitted as an information element (e.g., ProSe Authorized) of an Initial Context SetUp message. If the eNB 1500 supports the identified capability/capabilities, the eNB 1500 may allocate and/or schedule (10-4) resources based on the authorization. If the eNB 1500 does not support the indentified ProSe capability/capabilities, the eNB 1500 may transmit an Initial Context SetUp Failure message to the MME 1400. If the eNB 1500 does not support the identified ProSe capability/capabilities, the eNB 1500 may support communications with the UE 1600 without supporting ProSe communications.

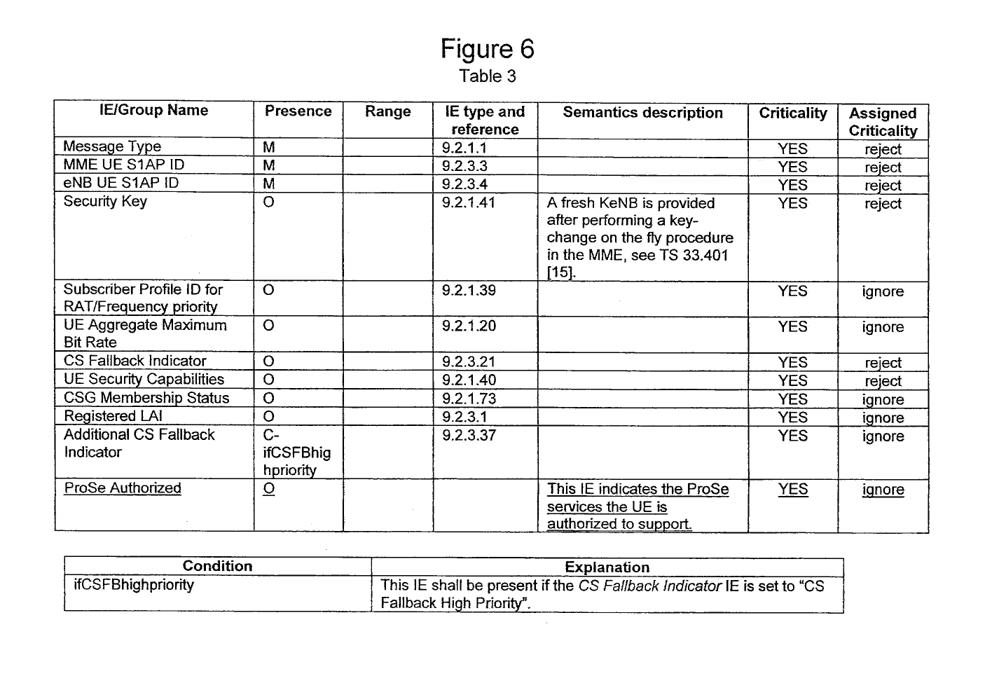

In case the UE capabilities or authorizations change, it may be possible for the MME 140 to signal such changes by adding the updated ProSe Authorized IE to the S1AP UE CONTEXT MODIFICATION REQUEST message (see, reference [6] 3GPP TS 36.413, v.12.1.0), as shown in Table 3 of FIG. 6. The modification is indicated with underlined.

If for some reason the eNB 1500 cannot accommodate the ProSe services as requested (e.g. if it does not allow D2D relay but only discovery and communication), it replies with the UE CONTEXT MODIFICATION FAILURE message including an appropriate cause value, e.g. “ProSe service not allowed”.

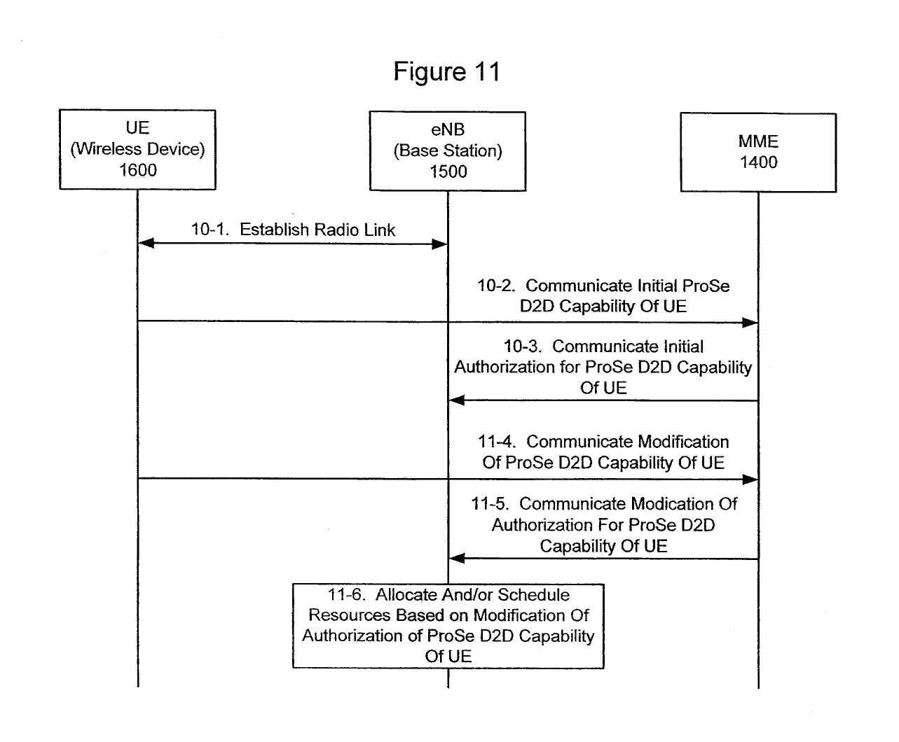

FIG. 11 is a message diagram illustrating use of a UE Context Modification Request message to communicate an authorization for a ProSe capability of a UE 1600 according to some embodiments. Operations 10-1, 10-2, and 10-3 may be the same as discussed above with respect to FIG. 10. After communicating the initial authorization 10-3, the UE 1600 may transmit (11-4) a communication (through the eNB 1500) to the MME 1400 modifying one or a plurality of ProSe D2D capability/capabilities (e.g., ProSe direct discovery, ProSe direct communication, and/or ProSe UE-to-network relay), and the MME 1400 may receive (11-4) the communication. The MME 1400 may then transmit (11-5) a modified authorization for a ProSe capability identifying at least one of a plurality of ProSe communication capabilities (e.g., ProSe direct discovery, ProSe direct communication, and/or ProSe UE-to-network relay) that may be different than the authorization of 10-3, and the eNB 1500 may receive (11-5) the modified authorization. The modified authorization may be transmitted as an information element (e.g., ProSe Authorized) of a UE Context Modification Request message. If the eNB 1500 supports the identified capability/capabilities, the eNB 1500 may allocate and/or schedule (11-6) resources based on the authorization. If the eNB 1500 does not support the indentified ProSe capability/capabilities of the modified authorization, the eNB 1500 may transmit a UE Context Modification Failure message to the MME 1400. If the eNB 1500 does not support the identified ProSe capability/capabilities of the modified authorization, the eNB 1500 may support communications with the UE 1600 without supporting ProSe communications.

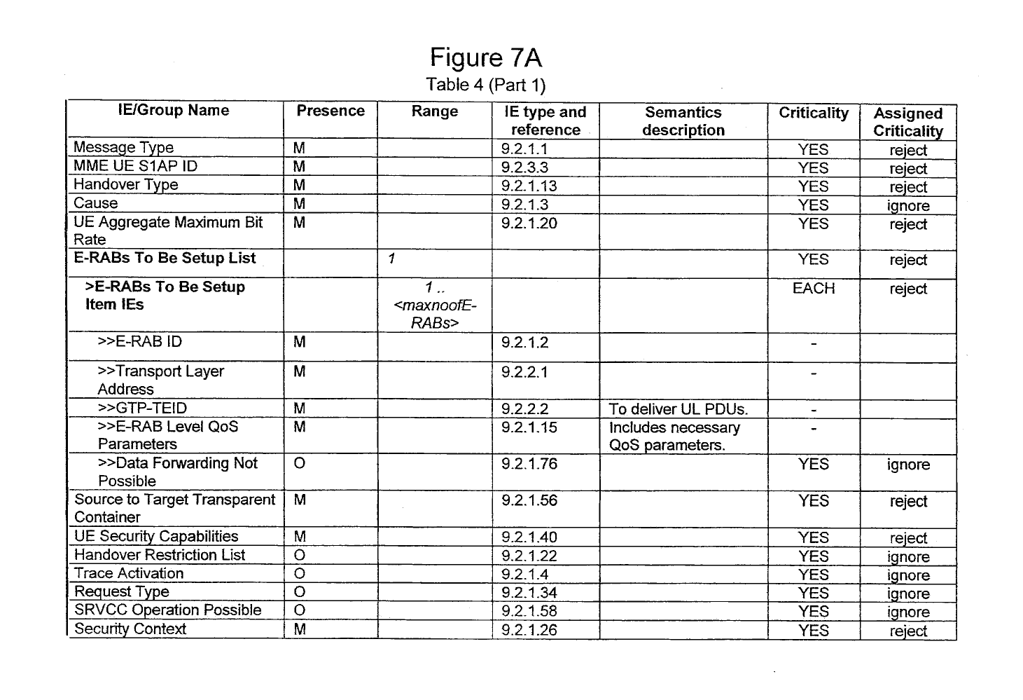

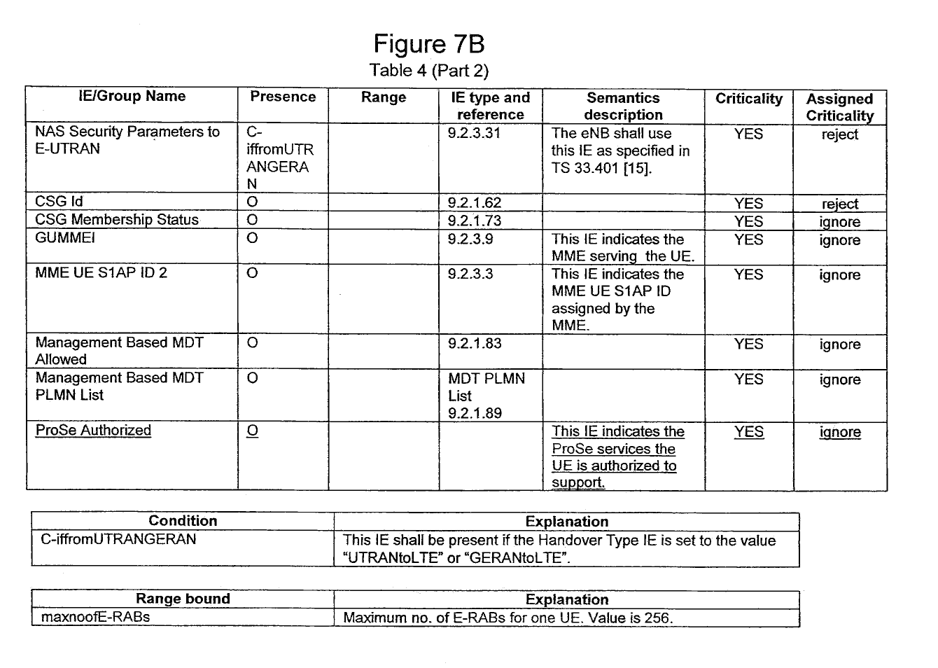

For S1 HO (HandOver), the ProSe Authorized IE can be added to the S1AP HANDOVER REQUEST message (see, reference [6], 3GPP TS 36.413, v.12.1.0), as shown in Table 4 of FIGS. 7A and 7B. This message may be sent from the MME 1400 to the target eNB 1500 during S1 HO. The modification is indicated with underlined in FIG. 7B.

If for some reason the target eNB 1500 cannot accommodate the ProSe services as requested (e.g., if the eNB does not allow D2D relay but only discovery and communication), the eNB 1500 may reply with a HANDOVER FAILURE message (see, reference [6]) including an appropriate cause value, e.g. “ProSe service not allowed”.

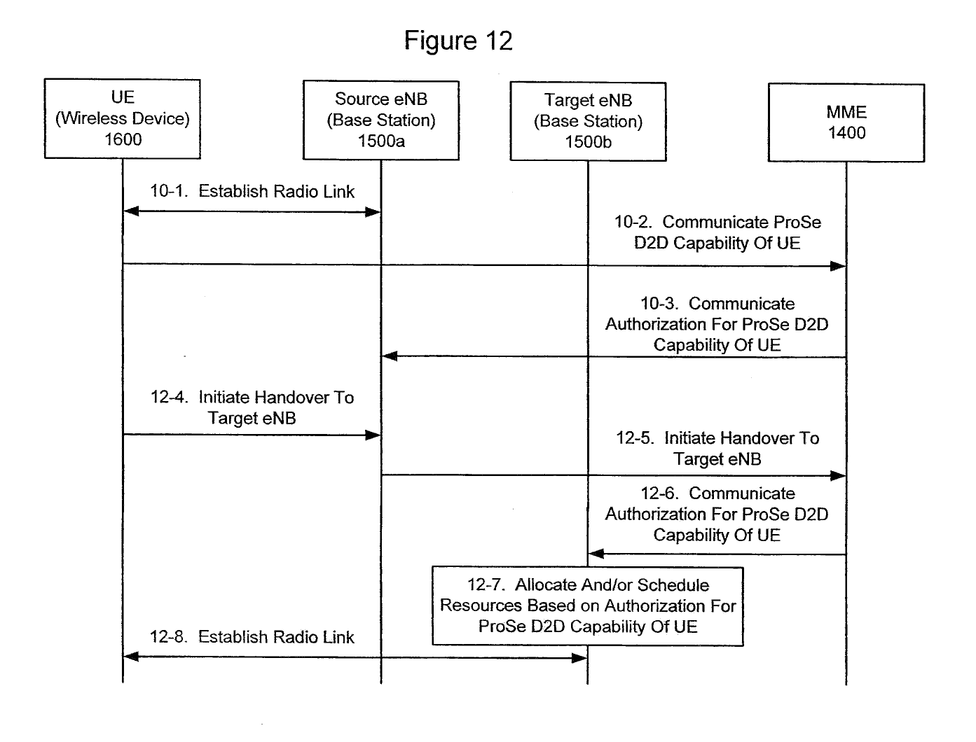

FIG. 12 is a message diagram illustrating use of an S1 HandOver Request message to communicate an authorization for a ProSe capability of a UE 1600 according to some embodiments. Operations 10-1, 10-2, and 10-3 may be the same as discussed above with respect to FIG. 10. After communicating the initial authorization 10-3, the UE 1600 may transmit (12-4) a communication (received at source eNB 1500a) to initiate a Handover to a target eNB 1500b, and the source eNB 1500a may transmit (12-5) a communication (received at the MME 1400) to initiate the Handover to the target eNB 1500b. From 10-2, the MME 1400 is aware of the ProSe capability/capabilities of the UE 1600. The MME 1400 may then transmit (12-6) an authorization for the ProSe capability identifying at least one of a plurality of ProSe communication capabilities (e.g., ProSe direct discovery, ProSe direct communication, and/or ProSe UE-to-network relay), and the target eNB 1500b may receive (12-6) the authorization. The authorization of 12-6 may be transmitted as an information element (e.g., ProSe Authorized) of an S1 HandOver Request message. For example, the authorizations of 10-3 and 12-6 may authorize the same ProSe capability/capabilities. If the target eNB 1500b supports the identified capability/capabilities, the target eNB 1500b may allocate and/or schedule (12-7) resources based on the authorization. If the target eNB 1500b does not support the indentified ProSe capability/capabilities of the authorization, the target eNB 1500b may transmit a HandOver Failure message to the MME 1400 (e.g., including an appropriate cause value). If the target eNB 1500b does not support the identified ProSe capability/capabilities of the authorization, the target eNB 1500b may support communications with the UE 1600 without supporting ProSe communications. Target eNB 1500b may establish 12-8 a radio link with the UE 1600.

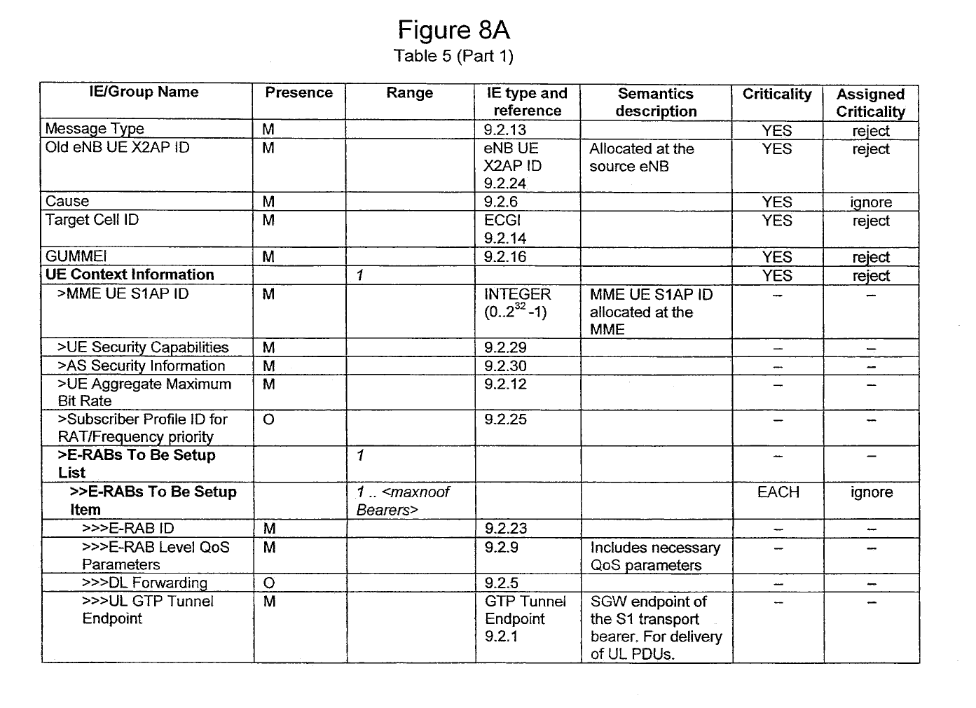

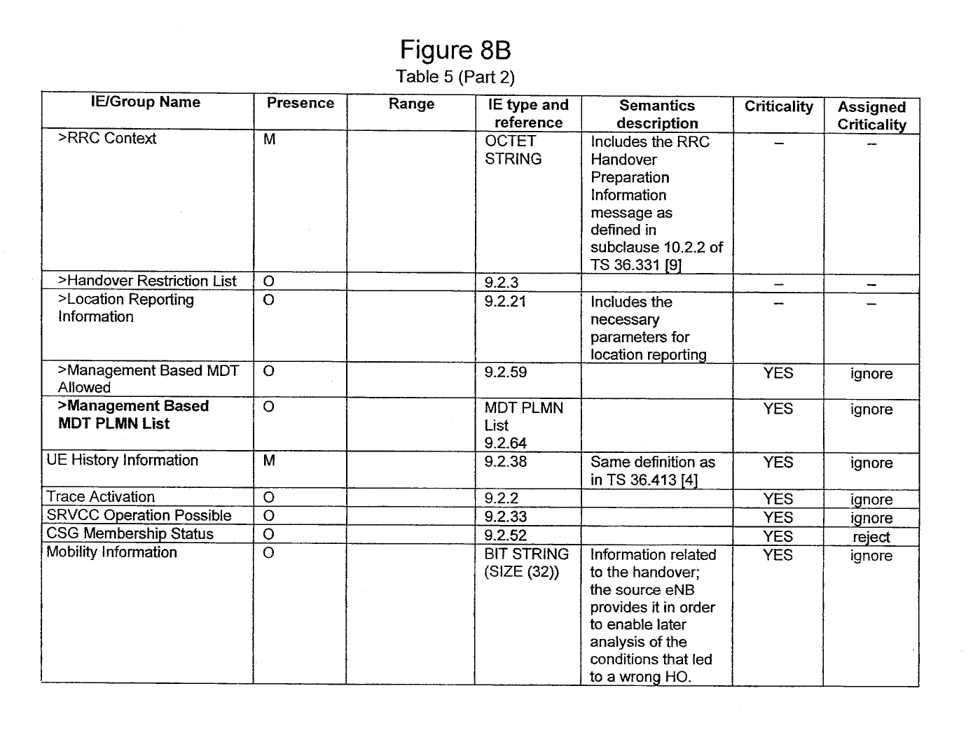

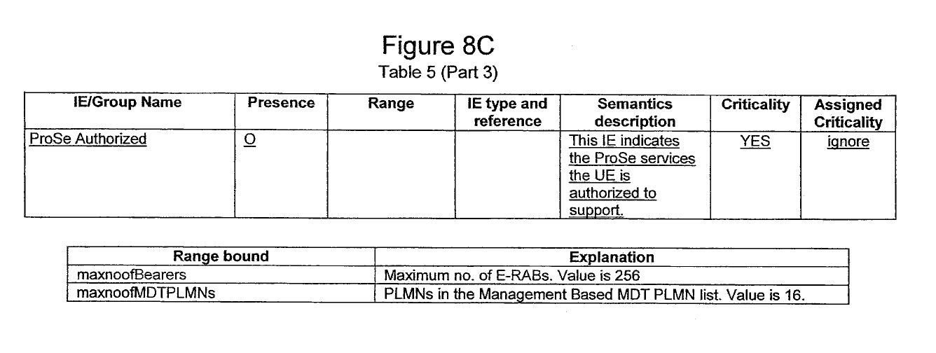

For X2 HO (HandOver), the ProSe Authorized IE can be added to the X2AP HANDOVER REQUEST message (see, reference [5], 3 GPP TS 36.423, v12.1.0), as shown in Table 5 of FIGS. 8A, 8B, and 8C. This message may be sent from the source eNB 1500a to the target eNB 1500b during X2 HO. The modification is indicated with underlined in FIG. 8C.

If for some reason the target eNB 1500b cannot accommodate the ProSe services as requested (e.g. if it does not allow D2D relay but only discovery and communication), the target eNB 1500b may reply with a HANDOVER PREPARATION FAILURE message (see, reference [5], 3 GPP TS 36.423, v12.1.0) including an appropriate cause value, e.g. “ProSe service not allowed”.

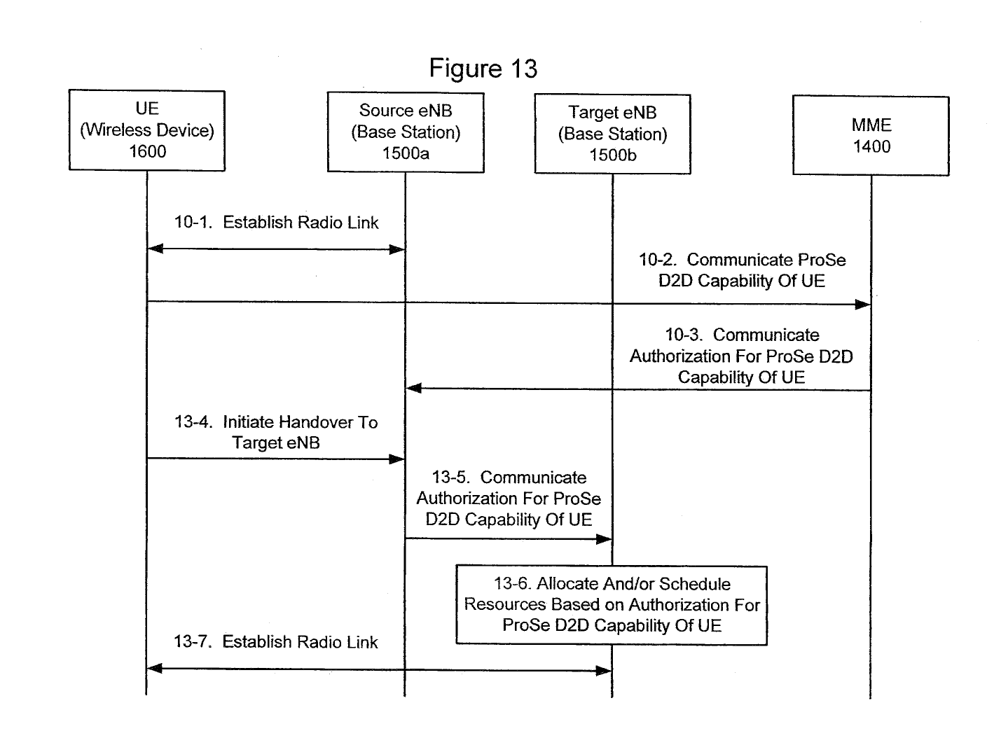

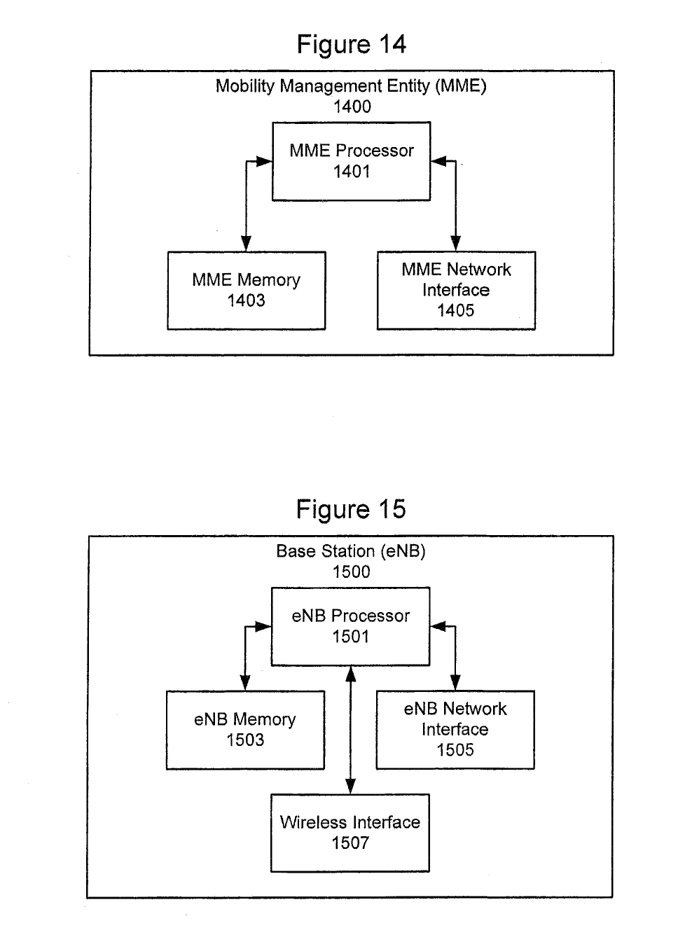

FIG. 13 is a message diagram illustrating use of an X2 HandOver Request message to communicate an authorization for a ProSe capability of a UE 1600 according to some embodiments. Operations 10-1, 10-2, and 10-3 may be the same as discussed above with respect to FIG. 10. After communicating the initial authorization 10-3, the UE 1600 may transmit (13-4) a communication (received at source eNB 1500a) to initiate a Handover to a target eNB 1500b. For example, the UE 1600 may implicitly request handover by sending a measurement report indicating, for example, that there is a change in radio conditions and/or that there is a new cell (e.g., served by the target eNB 1500b) which would be more suitable that the present cell (e.g., served by the source eNB 1500a) for serving the UE 1600. Such measurements may be included in the 13-4 communication of FIG. 13.

From the authorization 10-3, the source eNB 1500a is aware of the ProSe capability/capabilities of the UE 1600. The source eNB 1500a may then transmit (13-5) an authorization for the ProSe capability identifying at least one of a plurality of ProSe communication capabilities (e.g., ProSe direct discovery, ProSe direct communication, and/or ProSe UE-to-network relay), and the target eNB 1500b may receive (13-5) the authorization. The authorization of 13-5 may be transmitted as an information element (e.g., ProSe Authorized) of an X2 HandOver Request message. For example, the authorizations of 10-3 and 13-5 may authorize the same ProSe capability/capabilities. If the target eNB 1500b supports the identified capability/capabilities, the target eNB 1500b may allocate and/or schedule (13-6) resources based on the authorization. If the target eNB 1500b does not support the indentified ProSe capability/capabilities of the authorization, the target eNB 1500b may transmit a HandOver Preparation Failure message to the MME 1400 (e.g., including an appropriate cause value). If the target eNB 1500b does not support the identified ProSe capability/capabilities of the authorization, the target eNB 1500b may support communications with the UE 1600 without supporting ProSe communications. Target eNB 1500b may establish 13-7 a radio link with the UE 1600.

According to some embodiments, with the assigned criticality for the new IE set to “ignore” as shown in Table 2 (FIGS. 5A-C), Table 3 (FIG. 6), Table 4 (FIGS. 7A-B), and Table 5 (FIGS. 8A-C) as discussed above, an eNB which does not support the feature may allow connection, context modification, and/or handover of the UE ignoring the ProSe capability. Current system behavior may thus be preserved.

When receiving the ProSe Authorized IE in the messages discussed above above, the eNB may consider that the UE is authorized for the indicated type of ProSe service, and the eNB can allocate its internal resources and/or schedule/reschedule its served UEs accordingly.

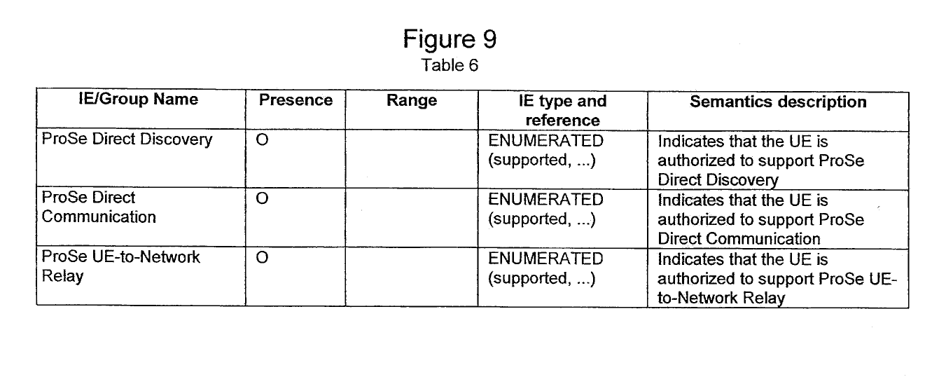

In some other embodiments of inventive concepts, the ProSe Authorized IE may be defined as a list of values, in order to accommodate ProSe UEs which support more than one type of service at a time. This is shown in Table 6 (FIG. 9). This definition allows signaling authorization for multiple types of services for the same UE.

All other considerations, including the use in all discussed S1AP and X2AP messages, are the same as for the previous embodiments with the ProSe Authorized IE defined as an “enumerated” type value as described above.

An MME 1400 of FIGS. 10-13 may be a node of a radio access network (RAN), and the MME 1400 may include an MME processor 1401, an MME memory 1403 coupled to the processor 1401, and an MME network interface 1405 coupled to the processor 1401. The MME network interface 1405 may provide communications between the MME processor 1401 and eNBs (base stations) of the radio access network according to an S1 interface protocol. Moreover, the MME memory 1403 may store computer program instructions that when executed by the MME processor 1401 allow the MME processor 1401 to perform MME operations discussed above with respect to FIGS. 10-13 and as discussed below with respect to Example Embodiments.

An eNB or base station 1500 of FIGS. 10-13 (including a source eNB 1500a, a target eNB 1500b, a serving eNB, etc.) may be coupled to the MME 1400 via an S1 Interface and may be coupled to other eNBs via X2 interfaces. An eNB 1500 may include an eNB processor 1501, an eNB memory 1503 coupled to the eNB processor, a network interface 1505 coupled to the eNB processor 1501, and a wireless interface (or transceiver) 1507 coupled to the eNB processor 1501. The eNB network interface 1505 may provide communications between the eNB processor 1501 and other eNBs of the radio access network according to an X2 interface protocol, and the eNB network interface 1505 may provide communications between the eNB processor 1501 and the MME 1400 according to the S1 interface. The wireless interface 1507 may provide wireless communications with UEs operating within a cell(s) defined by the wireless interface 1507. Moreover, the eNB memory 1503 may store computer program instructions that when executed by the eNB processor 1501 allow the eNB processor 1501 to perform eNB operations discussed above with respect to FIGS. 10-13 and as discussed below with respect to Example Embodiments.

As used herein, the term radio access network may include a radio interface node or nodes (e.g., a base station or eNB) and/or a core network node or nodes (e.g., a mobility management entity or MME).

### Example Embodiments

Example embodiments will now be discussed, by way of example, with reference to FIGS. 10, 11, 12, and 13.

### Embodiment 1

A method of operating a first node in a radio access network, the method comprising: communicating (10-3, 11-5, 12-6, 13-5) an authorization for a Proximity Services, ProSe, capability of a wireless device with a second node of the radio access network, wherein the authorization identifies at least one of a plurality of ProSe communication capabilities.

### Embodiment 2

The method of Embodiment 1 wherein communicating comprises communicating (10-3) the authorization for the ProSe capability of the wireless device as an information element, IE, of an Initial Context Setup Request message.

### Embodiment 3

The method of Embodiment 1 wherein communicating comprises communicating (11-5) the authorization for the ProSe capability of the wireless device as an information element, IE, of a UE Context Modification Request message.

### Embodiment 4

The method of Embodiment 1 wherein communicating comprises communicating (12-6) the authorization for the ProSe capability of the wireless device as an information element, IE, of an S1 Handover Request message.

### Embodiment 5

The method of any of Embodiments 1-4 wherein the first node comprises a base station, wherein the second node comprises a Mobility Management Entity, and wherein communicating comprises receiving the authorization for the ProSe capability at the base station from the Mobility Management Entity.

### Embodiment 6

The method of Embodiment 5 further comprising: allocating and/or scheduling air-interface resources of the base station based on the authorization for the ProSe capability of the wireless device.

### Embodiment 7

The method of any of Embodiments 1-4 wherein the first node comprises a Mobility Management Entity, wherein the second node comprises a base station, and wherein communicating comprises transmitting the authorization for the ProSe capability from the Mobility Management Entity to the base station.

### Embodiment 8

The method of any of Embodiments 7 wherein the base station is a handover target base station for the wireless device, the method further comprising: receiving (12-5) a handover request from a handover source base station for the wireless device at the Mobility Management Entity, wherein transmitting (12-6) comprises transmitting the authorization for the ProSe capability of the wireless device from the Mobility Management Entity to the handover target base station for the wireless device responsive to receiving the handover request from the handover source base station.

### Embodiment 9

The method of Embodiment 1 wherein communicating comprises communicating (13-5) the authorization for the ProSe capability as an information element, IE, of an X2 Handover Request message.

### Embodiment 10

The method of Embodiment 9 wherein the first node comprises a handover target base station for the wireless device, wherein the second node comprises a handover source base station for the wireless device, and wherein communicating comprises receiving (13-5) the X2 Handover Request message including the authorization for the ProSe capability at the handover target base station from the handover source base station.

### Embodiment 11

The method of Embodiment 10 further comprising: allocating and/or scheduling air-interface resources at the handover target base station based on the authorization for the ProSe capability of the wireless device.

### Embodiment 12

The method of Embodiment 9 wherein the first node comprises a handover source base station for the wireless device, wherein the second node comprises a handover target base station for the wireless device, and wherein communicating comprises transmitting (13-5) the X2 Handover Request Message including the authorization for the ProSe capability from the handover source base station to the handover target base station.

### Embodiment 13

The method of Embodiment 12 further comprising: receiving (10-3) the authorization for the ProSe capability of the wireless device at the handover source base station from a Mobility Management Entity before transmitting the authorization for the ProSe capability of the wireless device to the handover target base station.

### Embodiment 14

The method of any of Embodiments 12-13, the method further comprising: receiving (13-4) a handover request at the handover source base station from the wireless device, wherein transmitting (13-5) comprises transmitting the X2 Handover Request Message including the authorization for the ProSe capability of the wireless device from the handover source base station to the handover target base station responsive to receiving the handover request from the wireless device.

### Embodiment 15

The method of any of Embodiments 12-13, the method further comprising: receiving (13-4) a communication from the wireless terminal at the handover source base station to initiate a handover from the handover source base station, wherein transmitting (13-5) comprises transmitting the X2 Handover Request Message including the authorization for the ProSe capability of the wireless device from the handover source base station to the handover target base station responsive to receiving the communication from the wireless device.

### Embodiment 16

The method of any of Embodiments 1-15 wherein the authorization for the ProSe capability comprises authorization for the wireless device to support a ProSe Device-to-Device, D2D, capability of the wireless device.

### Embodiment 17

The method of any of Embodiments 1-16 wherein communicating the authorization for the ProSe capability of the wireless device comprises communicating an authorization for the wireless device to support at least one of ProSe direct discovery transmissions, ProSe direct communication transmissions, and/or UE-to-network relay. transmissions.

### Embodiment 18

The method of any of Embodiments 1-16 wherein communicating the authorization for the ProSe capability of the wireless device comprises communicating an authorization for the wireless device to support only one of ProSe direct discovery transmissions, ProSe direct communication transmissions, or UE-to-network relay transmissions.

### Embodiment 19

The method of any of Embodiments 1-18 wherein the authorization for the ProSe capability comprises authorization for the wireless device to support direct communication with another wireless device using frequency resources of the radio access network.

### Embodiment 20

The method of Embodiment 19 wherein the direct communication between the wireless devices comprises direct communication that does not pass through any nodes of the radio access network.

### Embodiment 21

A first network node of a radio access network, the first network node comprising: a network interface configured to communicate with a second network node of the radio access network, and a processor coupled to the network interface, wherein the processor is configured to communicate an authorization for a Proximity Services, ProSe, capability of a wireless device with a second node of the radio access network through the network interface, wherein the authorization identifies at least one of a plurality of ProSe communication capabilities.

### Embodiment 22

The first network node of Embodiment 21 wherein the processor is configured to communicate the authorization for the ProSe capability of the wireless device as an information element, IE, of an Initial Context Setup Request message.

### Embodiment 23

The first network node of Embodiment 21 wherein the processor is configured to communicate the authorization for the ProSe capability of the wireless device as an information element, IE, of a UE Context Modification Request message.

### Embodiment 24

The first network node of Embodiment 21 wherein the processor is configured to communicate the authorization for the ProSe capability of the wireless device as an information element, IE, of an S1 Handover Request message.

### Embodiment 25

The first network node of Embodiment 21 wherein the processor is configured to communicate the authorization for the ProSe capability as an information element, IE, of an X2 Handover Request message.

### Embodiment 26

The first network node of any one of Embodiments 21-25 wherein the processor is configured to communicate the authorization for the ProSe capability by receiving the authorization from the second network node through the network interface.

### Embodiment 27

The first network node of any one of Embodiments 21-25 wherein the processor is configured to communicate the authorization for the ProSe capability by transmitting the authorization to the second network node through the network interface.

### Embodiment 28

A first node for use in a radio access network, the first node being adapted to: communicate an authorization for a Proximity Services, ProSe, capability of a wireless device with a second node of the radio access network, wherein the authorization identifies at least one of a plurality of ProSe communication capabilities.

### Embodiment 29

The first node of Embodiment 28 wherein the first node is adapted to communicate the authorization for the ProSe capability of the wireless device as an information element, IE, of an Initial Context Setup Request message.

### Embodiment 30

The first node of Embodiment 28 wherein the first node is adapted to communicate the authorization for the ProSe capability of the wireless device as an information element, IE, of a UE Context Modification Request message.

### Embodiment 31

The first node of Embodiment 28 wherein the first node is adapted to communicate the authorization for the ProSe capability of the wireless device as an information element, IE, of an S1 Handover Request message.

### Embodiment 32

The first node of any of Embodiments 28-31 wherein the first node comprises a base station, wherein the second node comprises a Mobility Management Entity, and wherein the first node is adapted to communicate by receiving the authorization for the ProSe capability at the base station from the Mobility Management Entity.

### Embodiment 33

The first node of Embodiment 32 wherein the first node is further adapted to: allocate and/or schedule air-interface resources of the base station based on the authorization for the ProSe capability of the wireless device.

### Embodiment 34

The first node of any of Embodiments 28-31 wherein the first node comprises a Mobility Management Entity, wherein the second node comprises a base station, and wherein the first node is adapted to communicate by transmitting the authorization for the ProSe capability from the Mobility Management Entity to the base station.

### Embodiment 35

The first node of Embodiment 34 wherein the base station is a handover target base station for the wireless device, wherein the first node is further adapted to: receive a handover request from a handover source base station for the wireless device at the Mobility Management Entity, wherein the first node is adapted to transmit the authorization for the ProSe capability of the wireless device from the Mobility Management Entity to the handover target base station for the wireless device responsive to receiving the handover request from the handover source base station.

### Embodiment 36

The first node of Embodiment 28 wherein the first node is adapted to communicate the authorization for the ProSe capability as an information element, IE, of an X2 Handover Request message.

### Embodiment 37

The first node of Embodiment 36 wherein the first node comprises a handover target base station for the wireless device, wherein the second node comprises a handover source base station for the wireless device, and wherein the first node is adapted to communicate by receiving the X2 Handover Request message including the authorization for the ProSe capability at the handover target base station from the handover source base station.

### Embodiment 38

The first node of Embodiment 37, wherein the first node is further adapted to: allocate and/or schedule air-interface resources at the handover target base station based on the authorization for the ProSe capability of the wireless device.

### Embodiment 39

The first node of Embodiment 36 wherein the first node comprises a handover source base station for the wireless device, wherein the second node comprises a handover target base station for the wireless device, and wherein the first node is adapted to communicate by transmitting the X2 Handover Request Message including the authorization for the ProSe capability from the handover source base station to the handover target base station.

### Embodiment 40

The first node of Embodiment 39 wherein the first node is further adapted to: receive the authorization for the ProSe capability of the wireless device at the handover source base station from a Mobility Management Entity before transmitting the authorization for the ProSe capability of the wireless device to the handover target base station.

### Embodiment 41

The first node of any of Embodiments 39-40, wherein the first node is further adapted to: receive a handover request at the handover source base station from the wireless device, wherein the first node is adapted to transmit the X2 Handover Request Message including the authorization for the ProSe capability of the wireless device from the handover source base station to the handover target base station responsive to receiving the handover request from the wireless device.

### Embodiment 42

The first node of any of Embodiments 39-40, wherein the first node is further adapted to: receive a communication from the wireless terminal at the handover source base station to initiate a handover from the handover source base station, wherein the first node is adapted to transmit the X2 Handover Request Message including the authorization for the ProSe capability of the wireless device from the handover source base station to the handover target base station responsive to receiving the communication from the wireless device.

### Embodiment 43

The first node of any of Embodiments 28-42 wherein the authorization for the ProSe capability comprises authorization for the wireless device to support a ProSe Device-to-Device, D2D, capability of the wireless device.

### Embodiment 44

The first node of any of Embodiments 28-43 wherein the first node is adapted to communicate the authorization for the ProSe capability of the wireless device by communicating an authorization for the wireless device to support at least one of ProSe direct discovery transmissions, ProSe direct communication transmissions, and/or UE-to-network relay transmissions.

### Embodiment 45

The first node of any of Embodiments 28-43 wherein the first node is adapted to communicate the authorization for the ProSe capability of the wireless device by communicating an authorization for the wireless device to support only one of ProSe direct discovery transmissions, ProSe direct communication transmissions, or UE-to-network relay transmissions.

### Embodiment 46

The first node of any of Embodiments 28-45 wherein the authorization for the ProSe capability comprises authorization for the wireless device to support direct communication with another wireless device using radio resources of the radio access network.

### Embodiment 47

The first node of Embodiment 46 wherein the direct communication between the wireless devices comprises direct communication that does not pass through any nodes of the radio access network.

### Embodiment 48

A first node for use in a radio access network, the first network node comprising: a communication module for communicating an authorization for a Proximity Services, ProSe, capability of a wireless device with a second node of the radio access network, wherein the authorization identifies at least one of a plurality of ProSe communication capabilities.

### Embodiment 49

A network node of a radio access network adapted to perform according to any one of Embodiments 1-20.

### Embodiment 50

An MME network node of a radio access network adapted to perform according to any one of Embodiments 1-4, 7-8, and 16-20.

### Embodiment 51

A base station network node of a radio access network adapted to perform according to any one of embodiments 1-6 and 9-20.

### ABBREVIATIONS

3GPP 3rd Generation Partnership Project

AS Application Server

EPC Evolved Packet Core

E-UTRAN Evolved Universal Terrestrial Radio Access Network

D2D Device-to-Device

eNB Enhanced NodeB

HO HandOver

IE Information Element

LTE Long-Term Evolution

MME Mobility Management Entity

ProSe Proximity Services

QoS Quality of Service

S-GW Serving GateWay

UE User Equipment (or User Equipment node)

### REFERENCES

The disclosures of each of the following references are hereby incorporated herein the their entireties by reference.

[1] 3GPP TR 22.803 v. 12.2.0 (2013-06).

[2] R3-131685, Rapporteur Presentation on SI for D2D, Qualcomm Incorporated, Venice Italy, Oct. 7-11, 2013.

[3] RP-122009, Study on LTE Device to Device Proximity Services, Qualcomm Incorporated.

[4] 3GPP TS 36.300 v. 12.1.0 (2014-03).

[5] 3GPP TS 36.423 v. 12.1.0 (2014-03).

[6] 3GPP TS 36.413 v. 12.1.0 (2014-03).

[7] 3GPP TS 23.303 v. 12.0.0 (2014-02).

### FURTHER DEFINITIONS

When an element is referred to as being “connected”, “coupled”, “responsive”, or variants thereof to another element, it can be directly connected, coupled, or responsive to the other element or one or more intervening elements may be present. In contrast, when an element is referred to as being “directly connected”, “directly coupled”, “directly responsive”, or variants thereof to another element, there are no intervening elements present. Like numbers refer to like nodes/elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or”, abbreviated “/”, includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but do not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. Examples of embodiments of aspects of present inventive concepts explained and illustrated herein include their complimentary counterparts. The same reference numerals or the same reference designators denote the same or similar elements throughout the specification.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit (also referred to as a processor) of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Other network elements, communication devices and/or methods according to embodiments of inventive concepts will be or become apparent to one with skill in the art upon review of the present drawings and description. It is intended that all such additional network elements, devices, and/or methods be included within this description, be within the scope of the present inventive concepts. Moreover, it is intended that all embodiments disclosed herein can be implemented separately or combined in any way and/or combination.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended claims are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the following claims and their equivalents, and shall not be restricted or limited by the foregoing detailed description.

1. A method of operating a first node in a radio access network, the method comprising:
communicating an authorization for a Proximity Services, ProSe, capability of a wireless device with a second node of the radio access network, wherein the authorization identifies at least one of a plurality of ProSe communication capabilities.

2. The method of claim 1 wherein communicating comprises communicating the authorization for the ProSe capability of the wireless device as an information element, IE, of an Initial Context Setup Request message.

3. The method of claim 1 wherein communicating comprises communicating the authorization for the ProSe capability of the wireless device as an information element, IE, of a UE Context Modification Request message.

4. The method of claim 1 wherein communicating comprises communicating the authorization for the ProSe capability of the wireless device as an information element, IE, of an S1 Handover Request message.

5. The method of claim 1, wherein the first node comprises a base station, wherein the second node comprises a Mobility Management Entity, and wherein communicating comprises receiving the authorization for the ProSe capability at the base station from the Mobility Management Entity.

6. The method of claim 5 further comprising:
allocating and/or scheduling air-interface resources of the base station based on the authorization for the ProSe capability of the wireless device.

7. The method of claim 1, wherein the first node comprises a Mobility Management Entity, wherein the second node comprises a base station, and wherein communicating comprises transmitting the authorization for the ProSe capability from the Mobility Management Entity to the base station.

8. The method of claim 7 wherein the base station is a handover target base station for the wireless device, the method further comprising:
receiving a handover request from a handover source base station for the wireless device at the Mobility Management Entity,
wherein transmitting comprises transmitting the authorization for the ProSe capability of the wireless device from the Mobility Management Entity to the handover target base station for the wireless device responsive to receiving the handover request from the handover source base station.

9. The method of claim 1 wherein communicating comprises communicating the authorization for the ProSe capability as an information element, IE, of an X2 Handover Request message.

10. The method of claim 9 wherein the first node comprises a handover target base station for the wireless device, wherein the second node comprises a handover source base station for the wireless device, and wherein communicating comprises receiving the X2 Handover Request message including the authorization for the ProSe capability at the handover target base station from the handover source base station.

11. The method of claim 10 further comprising:
allocating and/or scheduling air-interface resources at the handover target base station based on the authorization for the ProSe capability of the wireless device.

12. The method of claim 9 wherein the first node comprises a handover source base station for the wireless device, wherein the second node comprises a handover target base station for the wireless device, and wherein communicating comprises transmitting the X2 Handover Request Message including the authorization for the ProSe capability from the handover source base station to the handover target base station.

13. The method of claim 12 further comprising:
receiving the authorization for the ProSe capability of the wireless device at the handover source base station from a Mobility Management Entity before transmitting the authorization for the ProSe capability of the wireless device to the handover target base station.

14. The method of claim 12, the method further comprising:
receiving a handover request at the handover source base station from the wireless device,
wherein transmitting comprises transmitting the X2 Handover Request Message including the authorization for the ProSe capability of the wireless device from the handover source base station to the handover target base station responsive to receiving the handover request from the wireless device.

15. The method of claim 12, the method further comprising:
receiving a communication from the wireless terminal at the handover source base station to initiate a handover from the handover source base station,
wherein transmitting comprises transmitting the X2 Handover Request Message including the authorization for the ProSe capability of the wireless device from the handover source base station to the handover target base station responsive to receiving the communication from the wireless device.

16. The method of claim 1, wherein the authorization for the ProSe capability comprises authorization for the wireless device to support a ProSe Device-to-Device, D2D, capability of the wireless device.

17. The method of claim 1, wherein communicating the authorization for the ProSe capability of the wireless device comprises communicating an authorization for the wireless device to support at least one of ProSe direct discovery transmissions, ProSe direct communication transmissions, and/or UE-to-network relay transmissions.

18. The method of claim 1, wherein communicating the authorization for the ProSe capability of the wireless device comprises communicating an authorization for the wireless device to support only one of ProSe direct discovery transmissions, ProSe direct communication transmissions, or UE-to-network relay transmissions.

19. The method of claim 1, wherein the authorization for the ProSe capability comprises authorization for the wireless device to support direct communication with another wireless device using radio resources of the radio access network.

20. The method of claim 19 wherein the direct communication between the wireless devices comprises direct communication that does not pass through any nodes of the radio access network.

21. A first node of a radio access network, the first node comprising:
a network interface configured to communicate with a second node of the radio access network, and
a processor coupled to the network interface, wherein the processor is configured to communicate an authorization for a Proximity Services, ProSe, capability of a wireless device with a second node of the radio access network through the network interface, wherein the authorization identifies at least one of a plurality of ProSe communication capabilities.

22. The first node of claim 21 wherein the processor is configured to communicate the authorization for the ProSe capability of the wireless device as an information element, IE, of an Initial Context Setup Request message.

23. The first node of claim 21 wherein the processor is configured to communicate the authorization for the ProSe capability of the wireless device as an information element, IE, of a UE Context Modification Request message.

24. The first node of claim 21 wherein the processor is configured to communicate the authorization for the ProSe capability of the wireless device as an information element, IE, of an S1 Handover Request message.

25. The first node of claim 21 wherein the processor is configured to communicate the authorization for the ProSe capability as an information element, IE, of an X2 Handover Request message.

26. The first node of claim 21 wherein the processor is configured to communicate the authorization for the ProSe capability by receiving the authorization from the second node through the network interface.

27. The first node of claim 21, wherein the processor is configured to communicate the authorization for the ProSe capability by transmitting the authorization to the second node through the network interface.

28.-47. (canceled)
